(19) United States
(12) Patent Application Publication
(10) Pub. No.: US 2026/0336046 A1
(43) Pub. Date: Oct. 29, 2026

(54) MACHINING ASSEMBLY AND METHOD OF EXCHANGING A MACHINING TOOL

(71) Applicant: Voortman Steel Machinery Holding B.V., Rijssen (NL)

(72) Inventor: Frans Herman VOLMER, Rijssen (NL)

(21) Appl. No.: 19/107,879

(22) PCT Filed: Nov. 9, 2023
(86) PCT No.: PCT/NL2023/050590

§ 371 Date: Feb. 28, 2025

(30) Foreign Application Priority Data
Nov. 10, 2022 (NL) 2033503

(51) Int. Cl. B23Q 3/157; B23Q 3/155; B23Q 39/02

(52) U.S. Cl. CPC B23Q 3/15773; B23Q 3/15536; B23Q 39/026

(57) ABSTRACT

Machining assembly for automatically machining a metal elongate profile shaped workpiece, comprising: at least three CNC-spindle heads, wherein each CNC-spindle head is configured to exchangeably receive a machining tool and controllable to simultaneously machine the workpiece using the received machining tool; a conveyor for transporting the workpiece along an X-axis with respect to the at least three CNC-spindle heads, the X-axis corresponding to a main axis of the elongate workpiece; a tool bank configured to hold a plurality of machining tools each suitable for each of the at least three CNC-spindle heads; and a tool exchanger assembly configured to selectively exchange machining tools between the tool bank on the one hand and any one of the at least three CNC-spindle heads on the other hand.

### FIELD

The invention relates to a machining assembly for automatically machining a metal elongate profile shaped workpiece, as well as to a method of exchanging a machining tool in such a machining assembly.

### BACKGROUND

Machining assemblies for automatically machining a metal elongate profile shaped workpiece are known as such. A known machining assembly comprises a CNC-spindle head configured to machine one side of the workpiece and to exchangeably receive a machining tool. The known machining assembly further comprises a tool bank configured to hold a plurality of machining tools, for example including drill bits, each suitable for the CNC-spindle head. A tool exchanger assembly may be configured to selectively exchange machining tools between the tool bank and the CNC-spindle head, in particular as an automated alternative to manual exchange of machining tools.

There is a continuing broad desire for improvements regarding automatic machining of metal elongate profile shaped workpieces.

### SUMMARY

An object of the present invention is to make the machining of metal elongate profile shaped workpieces more efficient, more versatile and/or more user friendly, in particular with respect to exchanging machining tools. An object is to at least partly resolve one or more disadvantages associated with a known machining assembly for automatically machining such workpieces, in particular while maintaining and/or extending existing advantages. An object is to at least provide an alternative method of exchanging a machining tool in such a machining assembly.

An aspect of the invention provides a machining assembly for automatically machining a metal elongate profile shaped workpiece. The machining assembly comprises at least three CNC-spindle heads. A first CNC-spindle head of the at least three CNC-spindle heads is configured to machine a first lateral side of the workpiece. A second CNC-spindle head of the at least three CNC-spindle heads is configured to machine a second lateral side of the workpiece opposite the first lateral side. A third CNC-spindle head of the at least three CNC-spindle heads is configured to machine an upwardly directed side of the workpiece. Each CNC-spindle head is configured to exchangeably receive a machining tool and controllable to simultaneously machine with each other of the at least three CNC-spindle heads the workpiece using the received machining tool.

The machining assembly further comprises a conveyor for transporting the workpiece along an X-axis with respect to the at least three CNC-spindle heads, the X-axis corresponding to a main axis of the elongate workpiece.

The machining assembly further comprises: a tool bank configured to hold a plurality of machining tools each suitable for each of the at least three CNC-spindle heads; and a tool exchanger assembly configured to selectively exchange machining tools between the tool bank on the one hand and any one of the at least three CNC-spindle heads on the other hand.

Advantageously, such a tool bank and tool exchanger assembly enable the machining assembly to use machining tools more efficiently, in particular by operationally sharing a same set of machining tools among the at least three CNC-spindle heads. Such a set may be referred to as a pool of machining tools. The pool may comprise, e.g. consist of, all machining tools held by the machining assembly, e.g. by the tool bank, by any of the CNC-spindle heads, and/or by any other part of the machining assembly.

For example, for a relatively rarely used type of tool, only one or two of such tools in the pool may suffice to enable each of the at least three CNC-spindle heads to use such a tool. By contrast, in known machining assemblies with separate tool banks and tool exchangers per CNC-spindle head, at least one such tool has to be included for each CNC-spindle head separately, thus yielding a total of at least three such tools or alternatively, manual exchange of the tools during production is required which is detrimental for the automated operation of the machining assembly.

Meanwhile, in such known machining assemblies, there may be times when a certain type of usable tool is lacking in one tool bank while it is available and not in use in another tool bank, for example because of differences in tool use over time among the different CNC-spindle heads. The combined tool bank and tool exchanger assembly of the present machining assembly help to avoid such situations by making a shared set of tools, i.e. a common pool of tools, operationally available to the multiple CNC-spindle heads.

Thus, a total number of machining tools in the machining assembly may be reduced while an availability of machining tools for each of the CNC-spindle heads can be maintained or even be improved. Similarly, the availability of tools may be improved while the total number of machining tools can be maintained or even reduced. As a consequence, the machining assembly can be more versatile and can be easier to use, in particular with a reduced operator work load regarding manual handling of tools.

It shall be appreciated that in the present context, the term ‘machining tool’ refers to a tool which is configured to be exchangeably received by a CNC-spindle head, to be brought in contact with the workpiece for machining the workpiece by said contact. Examples of relevant machining tools may include tool bits, for example a drill bit, a tap bit, a milling bit and a reamer bit. Such machining tools are generally subject to wear as a result of the contact with the workpiece and hence may generally need replacing after some amount of use. Next to wear, which is relatively predictable, breakage may also occur which can happen at any time and is therefore not predictable. In some instances the spindle head may also be used to mount a touch probe for performing measurements or a marking tool.

A further aspect provides a method of exchanging a machining tool in a machining assembly for automatically machining a metal workpiece. The method comprises: providing a machining assembly as described herein; and, using the tool exchanger assembly, selectively exchanging a machining tool between the tool bank on the one hand and any one of the at least three CNC-spindle heads on the other hand.

Such a method provides above mentioned advantages. In particular, the use of the tool exchanger assembly greatly enhances efficiency, versatility and user friendliness compared to known machining assemblies.

Further advantageous elaborations are provided by the features of the dependent claims, as will be explained further in the detailed description.

### DETAILED DESCRIPTION

In the following, the invention will be explained further using examples of embodiments and drawings. The drawings are schematic and merely show examples. In the drawings, corresponding elements are indicated by corresponding reference signs. In the drawings:

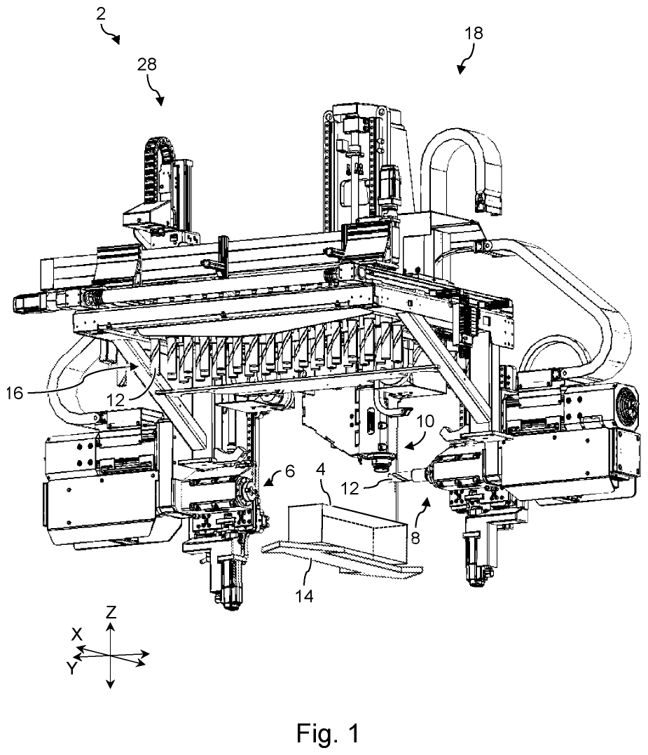

FIG. 1 shows a perspective view of an example of a machining assembly comprising a tool bank and tool exchanger assembly;

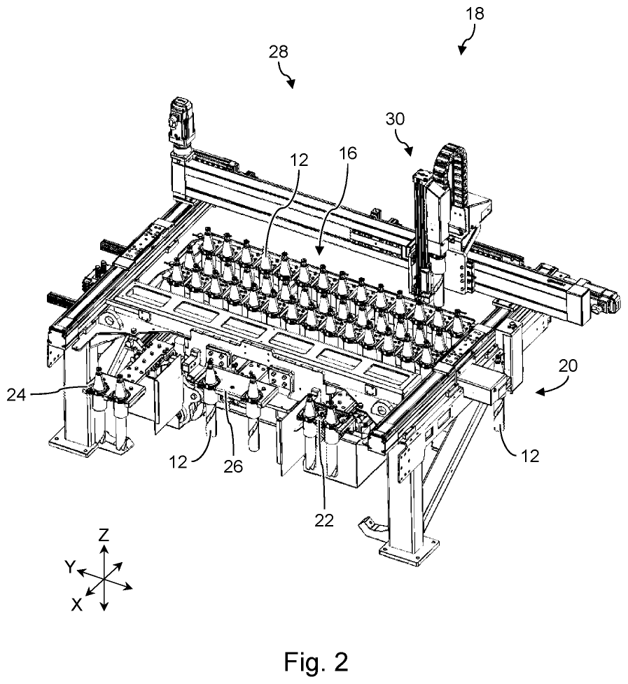

FIG. 2 shows a perspective view of the tool bank and tool exchanger assembly of FIG. 1; and

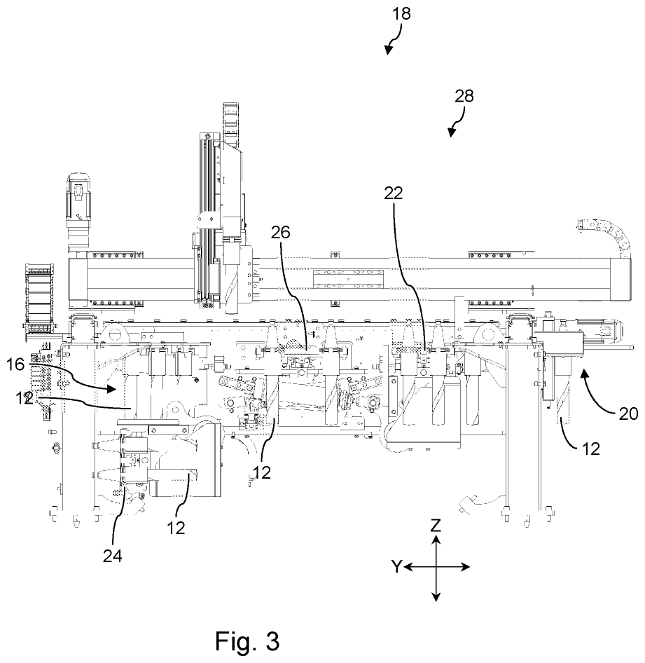

FIG. 3 shows a front view of a variation of the tool bank and tool exchanger assembly of FIG. 2, with one tool exchanger arm of the tool exchanger assembly in a different position compared to FIG. 2.

FIG. 1 shows a machining assembly 2 for automatically machining a metal elongate profile shaped workpiece 4. Merely as a schematic indication, a relatively small and simple workpiece 4 has been drawn in FIG. 1, wherein it shall be appreciated that metal elongate profile shaped workpieces can have various shapes and sizes, including with much larger lengths than what is shown in FIG. 1. In the shown examples, the main axis of the elongate workpiece will generally be aligned with the horizontal X-axis as indicated in the figures. The Y-axis then generally corresponds to a horizontal transverse direction and the Z-axis then generally corresponds to a vertical transverse direction.

The machining assembly 2 comprises at least three CNC-spindle heads 6, 8, 10. A first CNC-spindle head 6 of the at least three CNC-spindle heads is configured to machine a first lateral side of the workpiece 4. A second CNC-spindle head 8 of the at least three CNC-spindle heads is configured to machine a second lateral side of the workpiece 4 opposite the first lateral side. A third CNC-spindle head 10 of the at least three CNC-spindle heads is configured to machine an upwardly directed side of the workpiece 4. Thus, the first and second CNC-spindle heads 6 and 8 may be directed in mutually opposite directions along the Y-axis, while the third CNC-spindle head 10 may be downwardly directed along the Z-axis.

In embodiments, a respective position of each CNC-spindle head 6, 8, 10 with respect to the workpiece 4 is automatically adjustable, in particular in a plane transverse to a main axis of the workpiece 4. In the shown examples, such a transverse plane corresponds to a Y-Z-plane. It shall be appreciated that any one or more of the CNC-spindle heads 6, 8, 10 may additionally or alternatively be automatically adjustable along the X-axis.

Each CNC-spindle head 6, 8, 10 is configured to exchangeably receive a machining tool 12 and controllable to simultaneously with each other of the at least three CNC-spindle heads 6, 8, 10 machine the workpiece 4 using the received machining tool 12. In FIG. 1, CNC-spindle head 8 is shown with a machining tool 12 received thereby, wherein it shall be appreciated that such a machining tool can similarly be received by the other CNC-spindle heads 6 and 10.

The machining assembly 2 comprises a conveyor 14 for transporting the workpiece 4 along an X-axis with respect to the at least three CNC-spindle heads 6, 8, 10, the X-axis corresponding to a main axis of the elongate workpiece 4. Such a conveyor 14 has been indicated highly schematically in FIG. 1 as extending in an X-Y-plane, i.e. corresponding to a horizontal conveyor surface on which the workpiece 4 is supported. Various types of suitable conveyors are known as such, including e.g. roller conveyors. A gripper truck assembly (not shown) or other driving means may be provided for driving the workpiece 4 along the conveyor 14. Alternatively or additionally, the conveyor itself may be configured to drive the workpiece 4, e.g. by actuation of rollers, a belt, etc.

One or more clamping assemblies (not shown) may be provided at the machining assembly 2 to fixate the workpiece 4 during the machining, in particular clamping from one or more lateral sides of the workpiece 4, i.e. along the Y-axis, to stabilize the workpiece 4 during the machining.

The machining assembly 2 further comprises: a tool bank 16 configured to hold a plurality of machining tools 12 each suitable for each of the at least three CNC-spindle heads 6, 8, 10; and a tool exchanger assembly 18 configured to selectively exchange machining tools 12 between the tool bank 16 on the one hand and any one of the at least three CNC-spindle heads 6, 8, 10 on the other hand.

FIG. 2 shows the tool bank 16 and tool exchanger assembly 18 of the machining assembly 2 of FIG. 1, from a substantially opposite viewing direction compared to FIG. 1.

In each of the figures, one arbitrarily chosen machining tool 12 in the tool bank 16 has been indicated by a reference sign 12. In FIG. 2, it can be seen that the tool bank 16 comprises a total of 42 (three rows of 14) of such machining tools in this example. More generally, in embodiments, the number of machining tools 12 which the tool bank 16 is configured to hold is at least 20, preferably at least 30, more preferably at least 40, for example about 42.

It shall be appreciated that the tool bank 16 need not necessarily be completely filled with machining tools 12 as shown. Preferably, during use, one or more positions in the tool bank 16 are at least sometimes open to provide capacity for accepting tools 12 into the tool bank 16, e.g. in exchange for another tool leaving the tool bank 16.

In the shown examples, the machining tools 12 are shown as drill and milling bits. However, as indicated in the summary above, various different types of machining tools 12 can be used. Also, the machining tools used can generally be of various different sizes, e.g. drill or milling bits can have various diameters. More generally, during use, the tool bank 16 preferably holds a heterogeneous mix of machining tools, wherein the composition of the mix is preferably adapted to an expected tool use during an upcoming period of use of the machining assembly 2.

The figures also illustrate an example of a method of exchanging a machining tool 12 in a machining assembly 2 for automatically machining a metal workpiece 4. The method comprises: providing a machining assembly 2 as described herein; and, using the tool exchanger assembly 18, selectively exchanging a machining tool 12 between the tool bank 16 on the one hand and any one of the at least three CNC-spindle heads 6, 8, 10 on the other hand.

In embodiments, the tool exchanger assembly 18 comprises at least one tool exchanger arm 22, 24, 26 configured to move a machining tool 12 between a CNC-spindle head receipt position in which the machining tool 12 can be received by one of the CNC-spindle heads 6, 8, 10, and an exchange position of the tool exchanger arm 22, 24, 26.

Such a tool exchanger arm 22, 24, 26 can advantageously move a machining tool 12 to and/or from a CNC-spindle head 6, 8, 10. Thereby, one or more further parts of the tool exchanger assembly 18, in particular a tool transfer device 28 which is explained further elsewhere herein, can be of a relatively simple design. Moreover, in this way, tasks related to tool exchange may be performed in parallel, e.g. with multiple tool exchanger arms 22, 24, 26 operating in parallel with each other and/or in parallel with the tool transfer device 28.

In FIG. 2, two tool exchanger arms 22 and 26 are shown in such an exchange position, whereas one further tool exchanger arm 24 is shown in an intermediate position close to the exchange position. FIG. 3 shows a slight variation of the tool exchanger assembly 18 of FIG. 2 with a corresponding tool exchanger arm 24 in a CNC-spindle head receipt position. Notably, in this CNC-spindle head receipt position, the machining tools 12 are held substantially horizontally (along the Y-axis) by the tool exchanger arm 24 so as to facilitate exchange with the correspondingly directed CNC-spindle head 8. Meanwhile, in the tool bank 16 and in the exchange positions of the tool exchanger arms 22, 24, 26, the machining tools 12 may be held substantially vertically (along the Z-direction in the drawings) for efficient storage and stable positioning. However, in other embodiments, machining tools 12 could be held in different orientations in a tool bank.

It shall be appreciated that CNC-spindle head receipt positions of tool exchanger arms can thus substantially correspond to positions and directions of respective CNC-spindle heads. For example, to receive a machining tool held by a tool exchanger arm in a CNC-spindle head receipt position, the CNC-spindle head may be moved along the CNC-spindle head's main axis towards the tool exchanger arm to engage the machining tool, where after the tool exchanger arm may release the machining tool by moving away from the CNC-spindle head, in particular transverse to the CNC-spindle head's main axis.

In embodiments, e.g. as shown in FIGS. 2 and 3, the at least one tool exchanger arm 22, 24, 26 comprises a respective tool exchanger arm 22, 24, 26 for each of the CNC-spindle heads 6, 8, 10. In the shown examples, tool exchanger arms 22, 24, 26 thus correspond to CNC-spindle heads 6, 8, 10, respectively.

In this way, each CNC-spindle head 6, 8, 10 can have a respective tool exchanger arm 22, 24, 26 operating substantially independently of the other CNC-spindle heads, thereby further promoting versatility and efficiency of the tool exchanger assembly 18 and the overall machining assembly 2.

In embodiments, as alluded to above, the tool exchanger assembly 18 further comprises a tool transfer device 28 configured to transfer a machining tool 12 between the tool bank 16 and the at least one tool exchanger arm 22, 24, 26 in its exchange position.

In particular, the tool transfer device 28 may be configured to transfer machining tools 12 between any of the tool receiving positions of the tool bank and any tool exchanger arm 22, 24, 26 in its exchange position. Additionally, the tool transfer device 28 may be configured to transfer machining tools 12 among further combinations of positions, e.g. to and from a tool receipt station 20 which is explained further elsewhere herein.

In embodiments, the tool transfer device 28 comprises a tool engagement unit 30 configured to subsequently engage, lift, lower and release a machining tool 12, wherein the tool transfer device 28 is configured to move the tool engagement unit 30 horizontally between the lifting and the lowering so as to selectively position the tool engagement unit 30 over tool receiving positions of the tool bank 16 and/or over the tool exchanger arms 22, 24, 26 in their exchange positions.

In embodiments, each of the tool exchanger arms 22, 24, 26 has a different respective exchange position, wherein the tool transfer device 28 is configured to transfer a machining tool 12 to and from each of the exchange positions.

In this way, the tool transfer device 28 can for example exchange tools directly between the tool exchanger arms 22, 24, 26. Moreover, the tool exchanger arms 22, 24, 26 can thus always reach their respective exchange position without first having to wait for another of the exchanger arms 22, 24, 26.

In embodiments, the tool exchanger arm 22, 24, 26 is configured to hold multiple, e.g. two, machining tools 12 simultaneously for exchanging machining tools 12 at the CNC-spindle head 6, 8, 10 without requiring intermediate use of the tool transfer device 28.

Thus, for example, a tool exchanger arm 22, 24, 26 may bring one fresh machining tool towards a CNC-spindle head 6, 8, 10, then receive a spent tool from that CNC-spindle head, then cause the CNC-spindle head to receive the fresh machining tool, and only then move back towards the tool bank 16. This implies that the tool exchanger arm briefly simultaneously holds two machining tools, i.e. the spent tool and the fresh tool, close to the CNC-spindle head. In this way, the overall speed of exchanging tools can be increased compared to when a tool exchanger arm would only hold one machining tool at a time. Consequently, the effective operational time of the respective CNC-spindle head can be increased.

In FIGS. 2 and 3, each tool exchanger arm 22, 24, 26 can be seen to hold two machining tools 12 at or close to the exchange position. This is merely to illustrate how the arms 22, 24, 26 can be configured to hold two machining tools 12. It shall be appreciated that during use, the number of machining tools held by a tool exchanger arm 22, 24, 26 in its exchange position will generally be less than two, e.g. one or zero.

In embodiments, the tool exchanger assembly 18 is configured to exchange a machining tool 12 between the tool bank 16 and one of the CNC-spindle heads 6, 8, 10 while another one of the CNC-spindle heads 6, 8, 10 machines the workpiece 4.

Thus, advantageously, a tool exchange for one of the CNC-spindle heads need not affect the effective machining operations of the other CNC-spindle heads, while the at least three CNC-spindle heads can still benefit from the common tool exchanger assembly 18.

In embodiments, as seen for example in FIG. 2, the machining assembly 2 comprises a tool receipt station 20 outside the tool bank 16. The tool receipt station 20 is configured to receive an additional machining tool 12 for adoption into a pool of usable machining tools 12 held jointly by the tool bank 16, the tool exchanger assembly 18 and the plurality of CNC-spindle heads 6, 8, 10.

In this way, an operator can conveniently add and/or remove a machining tool 12 via the tool receipt station 20, while the machining assembly 2 can continue to machine the workpiece 4. In particular, the tool exchanger assembly 18 may be configured to automatically exchange a machining tool 12 to and/or from the tool receipt station 20, for example from and/or to the tool bank 16.

Correspondingly, in embodiments, the method comprises: using the tool exchanger assembly 18, adopting an additional machining tool 12 into a pool of usable machining tools 12 held jointly by the tool bank 16, the tool exchanger assembly 18 and the plurality of CNC-spindle heads 6, 8, 10.

In embodiments, the tool exchanger assembly 18 is configured to exchange a machining tool 12 directly between the tool receipt station 20 on the one hand and any one of the CNC-spindle heads 6, 8, 10 on the other hand. Additionally or alternatively, in embodiments, the tool exchanger assembly 18 may be configured to exchange a machining tool 12 directly between any two of the at least three CNC-spindle heads 6, 8, 10. Correspondingly, in embodiments, the method comprises: using the tool exchanger assembly 18, transferring a machining tool 12 from one of the CNC-spindle heads 6, 8, 10 directly to another one of the CNC-spindle heads 6, 8, 10. In this context, ‘directly’ can be understood as in particular not via the tool bank 16.

Thus, if desired, the tool bank 16 could be bypassed when a machining tool 12 is exchanged with respect to one or more of the CNC-spindle heads 6, 8, 10, thereby further promoting efficiency and versatility of the machining assembly 2.

In embodiments, the machining assembly 2 is configured to automatically mechanically sense a dimension of a machining tool 12 in the machining assembly 2. Correspondingly, in embodiments, the method comprises: by the machining assembly 2, automatically mechanically sensing a dimension of a machining tool 12 in the machining assembly 2.

In particular, the sensing of a dimension of a machining tool 12 may be performed in the tool exchanger assembly 18 so that the machining tool 12 can be measured prior to use.

In this way, the machining assembly 2 may automatically determine whether a machining tool 12 is suitable for use or e.g. needs to be replaced by a fresh tool, in particular via the tool receipt station 20. Alternatively or additionally, the machining assembly 2 may thus automatically determine an expected remaining machining capacity of the machining tool 12. In this respect, it has been found that mechanical sensing is more robust than e.g. optical sensing, and thus such automatic determining can be particularly reliable and effective.

In embodiments, the machining assembly 2 is configured to automatically remove a machining tool 12 from a pool of usable machining tools 12 held jointly by the tool bank 16, the tool exchanger assembly 18 and the at least three CNC-spindle heads 6, 8, 10 in response to a removal criterion, which may be automatically evaluated by the machining assembly 2.

In this way, it can be promoted that a limited available room in the tool bank 16 is utilized to hold machining tools 12 which are actually usable by the CNC-spindle heads. The automatic removal may prompt, at least be followed by, a replacement of the spent tool by a fresh tool, e.g. by an operator via the tool receipt station 20.

In embodiments, the removal criterion is based on at least one of: an automatic accounting, in particular by the machining assembly 2, of an amount of machining performed using the machining tool 12; and a mechanically sensed dimension of the machining tool 12, in particular sensed by the machining assembly 2.

The removal may be effected e.g. by the tool exchanger assembly 18 moving the relevant tool 12 to the tool receipt station 20 for removal therefrom by an operator. In such a case, the machining assembly 2 may send a corresponding notification to an operator, e.g. via a user interface for the operator.

Correspondingly, in embodiments, the method comprises: by the machining assembly 2, automatically removing a machining tool 12 from a pool of usable machining tools 12 held jointly by the tool bank 16, the tool exchanger assembly 18 and the plurality of CNC-spindle heads 6, 8, 10, wherein the removing may be dependent on an automatic determination by the machining assembly 2 that the machining tool 12 has become less suitable for use by the CNC-spindle heads 6, 8, 10.

Thus, the present invention advantageously enables the machining of metal elongate profile shaped workpieces to become more efficient, more versatile and more user friendly, in particular with respect to exchanging machining tools in a machining assembly.

Although the invention has been further explained herein using examples of embodiments, these do not limit the scope of the invention as defined by the claims. Within said scope, many variations, combinations and extensions are possible, as will be understood by the skilled person. For example, as a possible alternative to the described combination of the tool exchanger arms and the tool transfer device, a single more complex transfer device could move a machining tool between any position in the tool bank and any CNC-spindle head. Further examples have been provided throughout the description.

1. A machining assembly for automatically machining a metal elongate profile-shaped workpiece, comprising:
at least three CNC-spindle heads, wherein a first CNC-spindle head of the at least three CNC-spindle heads is configured to machine a first lateral side of the workpiece, wherein a second CNC-spindle head of the at least three CNC-spindle heads is configured to machine a second lateral side of the workpiece opposite the first lateral side, wherein a third CNC-spindle head of the at least three CNC-spindle heads is configured to machine an upwardly directed side of the workpiece, wherein each CNC-spindle head of the at least three CNC-spindle heads is configured to exchangeably receive a machining tool and controllable to simultaneously with each other of the at least three CNC-spindle heads machine the workpiece using the received machining tool;
a conveyor for transporting the workpiece along an X-axis with respect to the at least three CNC-spindle heads, the X-axis corresponding to a main axis of the workpiece;
a tool bank configured to hold a plurality of machining tools each of the plurality of machining tools suitable for each of the at least three CNC-spindle heads; and
a tool exchanger assembly configured to selectively exchange at least one first machining tool of the plurality of machining tools between the tool bank and any one of the at least three CNC-spindle heads.

2. The machining assembly according to claim 1, further comprising a tool receipt station outside the tool bank, wherein the tool receipt station is configured to receive an additional machining tool for adoption into a pool of usable machining tools held jointly by the tool bank, the tool exchanger assembly and the at least three CNC-spindle heads.

3. The machining assembly according to claim 2, wherein the tool exchanger assembly is additionally configured to exchange the machining tool directly between the tool receipt station and any one of the at least three CNC-spindle heads.

4. The machining assembly according to claim 1, wherein the tool exchanger assembly is additionally configured to exchange the machining tool directly between any two of the at least three CNC-spindle heads.

5. The machining assembly according to claim 1, wherein the tool exchanger assembly comprises:
at least one tool exchanger arm configured to move the machining tool between a CNC-spindle head receipt position, in which the machining tool can be received by one of the at least three CNC-spindle heads, and an exchange position of the at least one tool exchanger arm; and
a tool transfer device configured to transfer the machining tool between the tool bank and the at least one tool exchanger arm in the exchange position.

6. The machining assembly according to claim 5, wherein the at least one tool exchanger arm comprises a respective tool exchanger arm for each CNC-spindle head of the at least three CNC-spindle heads.

7. The machining assembly according to claim 6, wherein each respective tool exchanger arm has a different respective exchange position, wherein the tool transfer device is configured to transfer the machining tool to and from each of the respective exchange positions.

8. The machining assembly according to claim 5, wherein the at least one tool exchanger arm is configured to hold multiple machining tools simultaneously for exchanging machining tools at a CNC-spindle head of the at least three CNC-spindle heads without requiring intermediate use of the tool transfer device.

9. The machining assembly according to claim 1, wherein the plurality of machining tools the tool bank is configured to hold is at least 20.

10. The machining assembly according to claim 1, wherein the tool exchanger assembly is configured to exchange the machining tool between the tool bank and one of the at least three CNC-spindle heads while another one of the at least three CNC-spindle heads machines the workpiece.

11. The machining assembly according to claim 1, wherein the machining assembly is configured to automatically mechanically sense a dimension of the machining tool in the machining assembly.

12. The machining assembly according to claim 1, wherein the machining assembly is configured to automatically remove the machining tool from a pool of usable machining tools held jointly by the tool bank, the tool exchanger assembly and the at least three CNC-spindle heads in response to a removal criterion.

13. A method of exchanging a machining tool in a machining assembly for automatically machining a metal workpiece, comprising:
providing a machining assembly according to claim 1; and
using the tool exchanger assembly, selectively exchanging the machining tool between the tool bank and any one of the at least three CNC-spindle heads.

14. The method according to claim 13, further comprising: using the tool exchanger assembly, transferring the machining tool from one of the at least three CNC-spindle heads to another one of the at least three CNC-spindle heads.

15. The method according to claim 13, further comprising: using the tool exchanger assembly, adopting an additional machining tool into a pool of usable machining tools held jointly by the tool bank, the tool exchanger assembly and the at least three CNC-spindle heads.

16. The method according to claim 13, further comprising: automatically mechanically sensing by the machining assembly, a dimension of the machining tool in the machining assembly.

17. The method according to claim 13, comprising: automatically removing, by the machining assembly, the machining tool from a pool of usable machining tools held jointly by the tool bank, the tool exchanger assembly and the at least three CNC-spindle heads.

18. The method according to claim 17, wherein removing the machining tool is dependent on an automatic determination by the machining assembly that the machining tool has become less suitable for use by the at least three CNC-spindle heads.

19. The machining assembly according to claim 9, wherein the plurality of machining tools the tool bank is configured to hold is at least 30.

20. The machining assembly according to claim 19, wherein the plurality of machining tools the tool bank is configured to hold is at least 40.
